(19) United States
(12) Patent Application Publication
(10) Pub. No.: US 2025/0326103 A1
(43) Pub. Date: Oct. 23, 2025

(54) Work apparatus

(71) Applicant: Andreas Stihl AG & Co. KG, Waiblingen (DE)

(72) Inventors: Patrick Schindler, Weilheim an der Teck (DE); Denis Ehrler, Wernau (DE); Alexander Härtel, Waiblingen (DE)

(73) Assignee: Andreas Stihl AG & Co. KG, Waiblingen (DE)

(21) Appl. No.: 19/183,994

(22) Filed: Apr. 21, 2025

(30) Foreign Application Priority Data
Apr. 23, 2024 (DE) 102024111426.6
Apr. 23, 2024 (DE) 102024111428.2

(51) Int. Cl. B25F 5/00; H02K 5/24; H02K 7/14

(52) U.S. Cl. CPC B25F 5/006; H02K 5/24; H02K 7/145

(57) ABSTRACT

A work apparatus includes: a housing; a motor support unit designed separately from the housing, the housing being fixed to the motor support unit. A drive motor is designed as an electric motor for driving a tool and is attached to the motor support unit. A receptacle housing designed separately from the motor support unit for receiving at least one battery pack for supplying the drive motor with electrical power is fixed to the housing. The receptacle housing and the motor support unit are designed and arranged relative to each other in such a way that the receptacle housing is able to move relative to the motor support unit in order to reduce, in particular to prevent, direct transmission of inertial forces emanating from the receptacle housing to the motor support unit in the event of an impact load on the work apparatus.

### CROSS-REFERENCE TO RELATED APPLICATIONS

This application claims the benefit of German Patent Applications No. DE102024111426.6, filed 23-Apr.-2024, and DE102024111428.2, filed 23-Apr.-2024, the contents of both of which are incorporated by reference in their entireties.

### TECHNICAL FIELD

The disclosure relates to a work apparatus, for example a cut-off machine or a chainsaw.

### BACKGROUND

Handheld work apparatuses, in particular cut-off machines, are known, which comprise a housing, an electric motor arranged in the housing and a motor support unit. The electric motor as well as the housing are secured to the motor support unit. The electric motor is used to drive a tool that can be installed on the work apparatus. A battery pack attached to the housing serves as electrical energy source for the electric motor.

The disadvantage of such work apparatuses is that an impact load can damage the motor support unit. Such an impact load can be caused, for example, by the work apparatus being dropped on the ground. The impact load can in turn cause deformation of the motor support unit. If the motor support unit has been deformed or damaged, the efficiency at the very least, or in some cases the function of the electric motor as a whole, may be impaired, for example due to a lack of concentricity accuracy of the rotor.

### SUMMARY

It is an object of the disclosure to specify a work apparatus that has increased resistance to external loads, in particular impact loads. This object is solved by a work apparatus as disclosed and claimed.

The work apparatus comprises a housing; a motor support unit designed separately from the housing, the housing being fixed to the motor support unit; a drive motor arranged in the housing, wherein the drive motor is designed as an electric motor for driving a tool and is attached to the motor support unit; a receptacle housing designed separately from the motor support unit for receiving at least one battery pack for supplying the drive motor with electrical power, wherein the receptacle housing is fixed to the housing, and wherein the receptacle housing and the motor support unit are designed and arranged in relation to each other in such a way that the receptacle housing is able to move relative to the motor support unit in order to reduce, in particular to prevent direct transmission of inertial forces emanating from the receptacle housing to the motor support unit in the event of an impact load on the work apparatus.

When the work apparatus is in operation, at least one battery pack is received in the receptacle housing. Compared to other components, the battery pack has a particularly high mass, which means that the receptacle housing together with the battery pack exerts a high inertial force in the event of an impact load, for example if the work apparatus falls onto the ground. So that this inertial force does not act directly on the motor support unit and damage it, the receptacle housing for receiving the battery pack is decoupled from the motor support unit, i.e. it is designed to be able to move with respect to the motor support unit. Therefore, the receptacle housing is at least not directly attached to the motor support unit, but rather to the housing. The housing, which in turn is fixed to the motor support unit, damps the inertial forces emanating from the receptacle housing and the at least one battery pack, even before they can be transmitted to the motor support unit. The proportion of the inertial forces that acts on the motor support unit is then considerably lower than the inertial forces initially emanating from the receiving slot and the at least one battery pack. To ensure that the work apparatus can be guided precisely, the motor support unit is preferably designed to be as rigid as possible and therefore has only minimal damping capabilities. The housing is used as damping means between motor support unit and receiving slot. This can prevent damage to the motor support unit.

It is advantageously provided that the motor support unit and the receptacle housing are only connected to one another via the housing. The housing thus serves as the sole damping means between the motor support unit and the receptacle housing. The motor support unit and the receptacle housing are in particular arranged spaced apart from each other. Of course, this spacing between receptacle housing and motor support unit refers to an idle state of the work apparatus, in which it is not being moved and is not subject to any load, in particular impact load. As a result of the motor support unit being spaced apart from the receptacle housing, the housing can deform without corresponding forces and/or torques being transmitted directly from the receptacle housing to the motor support unit. Due to the deformation, preferably elastic deformation, of the housing, the inertial forces of the receptacle housing as well as of the at least one battery pack energy are absorbed, even before the receptacle housing can come into contact with the motor support unit owing to the deformation of the housing. The remaining forces that can be transmitted from the receptacle housing to the motor support unit are considerably reduced.

In particular, each connection between the housing and the motor support unit is free of a separately formed antivibration element. Very particularly, each connection between the housing and the receptacle housing is free of a separately formed antivibration element. The forces emanating from the receptacle housing are thus damped substantially via the housing.

The receptacle housing has in particular at least two receptacles for receiving two battery packs, wherein an opening through which the motor support unit projects is provided between the two receptacles. Therefore, the motor support unit is located between the two receptacles, which in turn are able to move with respect to the motor support unit. The two receptacles are not attached directly to the motor support unit.

It is preferably provided that the component rigidity of the motor support unit is greater than that of the housing. The housing is formed in particular from a plastic. The motor support unit is formed in particular from a metal material, in particular from a magnesium alloy. By forming the motor support unit from a metal material it is possible to give it a particularly rigid configuration. As a result, the motor support unit is dimensionally stable even under the operating load of the work apparatus. This can thus prevent the motor support unit becoming deformed. This is particularly beneficial to the operating characteristics of moving, in particular rotating, machine parts which are attached to the motor support unit. Unlike the motor support unit, the housing is formed from an elastic material, in particular plastic, whereby in particular this can also deform elastically.

It is particularly advantageously provided that the work apparatus has a rear handle and a front handle, wherein an actuating element for controlling the drive motor is assigned to the rear handle, and that the motor support unit has a rear end and a front end, and that the rear end faces away from the tool and the front end faces towards the tool, wherein the rear handle is attached in the rear region of the motor support unit and the front handle is attached in the front region of the motor support unit. The drive motor is attached between the front end and the rear end of the motor support unit. Particularly preferably, the rear handle is attached in the region of the rear end, in particular to the rear end of the motor support unit and the front handle is attached in the region of the front end, in particular to the front end of the motor support unit.

Handheld work apparatuses, in particular cut-off machines, are known, which comprise a housing, an electric motor arranged in the housing and a motor support unit. The electric motor as well as the housing are held on the motor support unit. A tool that can be installed on the work apparatus is driven by the electric motor. It is known to provide a battery pack which is held on the housing as electrical energy source for the electric motor. To achieve longer operation and a better performance of the work apparatus, two battery packs are also used in one work apparatus. The disadvantage of using two battery packs in a work apparatus is that a comparatively large amount of installation space is required to accommodate the battery packs on or in the housing of the work apparatus. Such work apparatuses are sometimes also unwieldy to operate.

It is an the object of the disclosure to specify a work apparatus that is intended to receive multiple battery packs yet has a compact installation space while being easy for the operator to handle.

This object is solved by a work apparatus as disclosed hereafter.

The work apparatus comprises a housing; a motor support unit designed separately from the housing and connected to the housing; a drive motor arranged in the housing, wherein the drive motor is designed as an electric motor and is attached to the motor support unit; a receptacle housing having at least one first receptacle and at least one second receptacle for receiving one battery pack each, wherein the motor support unit is arranged at least partially between the first receptacle and the second receptacle.

Due to this arrangement of motor support unit and the first receptacle and the second receptacle it is possible to divide up the installation space evenly, in particular symmetrically. The work apparatus thus has a compact design. Such a division of the installation space, in particular a symmetrical arrangement of the receptacles, in particular of the battery packs in relation to the motor support unit, enables the weight to be distributed optimally. This in turn makes the work apparatus easier to handle.

It is provided in particular that the motor support unit has a middle section, wherein the middle section has a first curvature and a second curvature, wherein the first curvature and the second curvature run in opposite directions to each other. Due to the design of two curvatures running in opposite directions to each other, the middle section has an offset. This gives rise to a region of the motor support unit that is arranged close to the housing and thus frees up a lot of installation space in the housing. The drive motor is preferably arranged in this region of the motor support unit. The other region is arranged offset from the first region by the middle section and thus runs centrally through the remaining installation space in the housing of the work apparatus. Thus, the remaining installation space is divided by the other region of the motor support unit into two smaller installation spaces. A receptacle of the receptacle housing is provided in each of the two installation spaces. The motor support unit is adapted to the installation space needed for the receptacles, in particular that of the battery packs, thus creating a compact design.

The first curvature has a first axis of curvature. The second curvature has a second axis of curvature. The first axis of curvature of the first curvature and the second axis of curvature of the second curvature are aligned in particular parallel to one another. The motor support unit is thus only curved once. This simplifies the manufacturing of the components in particular. Components with a single curvature are considerably easier to mould and demould than components with a double curvature.

It is provided in particular that the motor support unit has a first longitudinal section and a second longitudinal section, which are aligned in particular parallel to one another, wherein the first longitudinal section and the second longitudinal section are connected to one another via the middle section. Thus, the first longitudinal section and the second longitudinal section are arranged offset from one another.

The first longitudinal section of the motor support unit is arranged in particular between the first receptacle of the receptacle housing and the second receptacle of the receptacle housing. The first receptacle and the second receptacle are designed in particular as receiving slots. The first longitudinal section runs centrally in the housing interior and divides this, as stated above, into two smaller installation spaces. A receiving slot for a battery pack is provided in each one of the two smaller installation spaces. If the battery packs are designed as slide-in battery packs, the two smaller installation spaces can be designed as free installation spaces, each of which can receive at least one slide-in battery pack. The drive motor is attached to the second longitudinal section of the motor support unit. The second longitudinal section is arranged offset towards the housing in relation to the first longitudinal section. Due to the lateral arrangement of the second longitudinal section on the housing, the motor support unit frees up a comparatively large amount of installation space in the housing interior, in which the drive motor can be arranged.

It is provided in particular that the motor support unit is a motor support plate which is formed in particular from a metal alloy, in particular from a magnesium alloy. As a result, the motor support plate has great rigidity.

It is preferably provided that the motor support plate is a moulded component with a main demoulding direction, wherein the main demoulding direction corresponds to the direction of an axis of rotation of the drive motor. This in turn is conducive to forming a motor receptacle on the motor support unit. This is preferably formed from a hollow tube on which the rotor of the drive motor, in particular the drive shaft of the drive motor, is mounted. In particular, the stator, which is fixedly connected to the motor support unit, sits on the hollow tube.

It is provided in particular that the work apparatus has a rear handle and a front handle, wherein the rear handle is assigned an actuating element for controlling the drive motor. The motor support unit has in particular a rear end and a front end. In particular, the rear end faces away from the tool. In particular, the front end faces towards the tool. The rear handle is preferably attached in the rear region of the motor support unit and the front handle is advantageously attached in the front region of the motor support unit.

The work apparatus is designed in particular as a cut-off machine, as a chainsaw or similar work apparatus.

Exemplary embodiments of the invention are explained in more detail hereinafter with reference to the drawing, which shows:

### BRIEF DESCRIPTION OF THE DRAWINGS

FIG. 1 shows, in a perspective illustration, an embodiment of the handheld work apparatus.

FIG. 2 shows, in a side view, the handheld work apparatus according to FIG. 1.

FIG. 3 shows, in a side view, the handheld work apparatus according to FIG. 1 without a tool and in part without the arm being covered.

FIG. 4 shows, in a cutaway side illustration, the arm of the work apparatus according to FIG. 1 with pulley and belt.

FIG. 5 shows, viewed von above, a sectional illustration of the work apparatus according to FIG. 1.

FIG. 6 shows, viewed from above, a sectional illustration of the work apparatus according to FIG. 1 along the points of attachment of the housing to the motor support unit.

FIG. 7 shows, viewed from the rear, a sectional illustration of the work apparatus according to FIG. 1.

FIG. 8 shows, in a perspective illustration from the rear, the motor support unit of the work apparatus according to FIG. 1.

FIG. 9 shows, in a perspective illustration from the front, the motor support unit of the work apparatus according to FIG. 1.

FIG. 10 shows, in a plan view, the motor support unit of the work apparatus according to FIG. 1.

FIG. 11 shows, in a view from below, the motor support unit of the work apparatus according to FIG. 1.

FIG. 12 shows, in a lateral, perspective illustration, the work apparatus according to FIG. 1 in the open position of the protective hood.

FIG. 13 shows, in a lateral, perspective illustration, the work apparatus of according to FIG. 1 in the end position of the protective hood.

FIG. 14 shows, in a side illustration, the work apparatus according to FIG. 1 with schematically illustrated protective hood in the open position and end position.

FIG. 15 shows, in an illustration from below, the work apparatus according to FIG. 1.

FIG. 16 shows, in a lateral, enlarged illustration, the stop and mating stop of the work apparatus according to FIG. 1 in contact.

### DETAILED DESCRIPTION

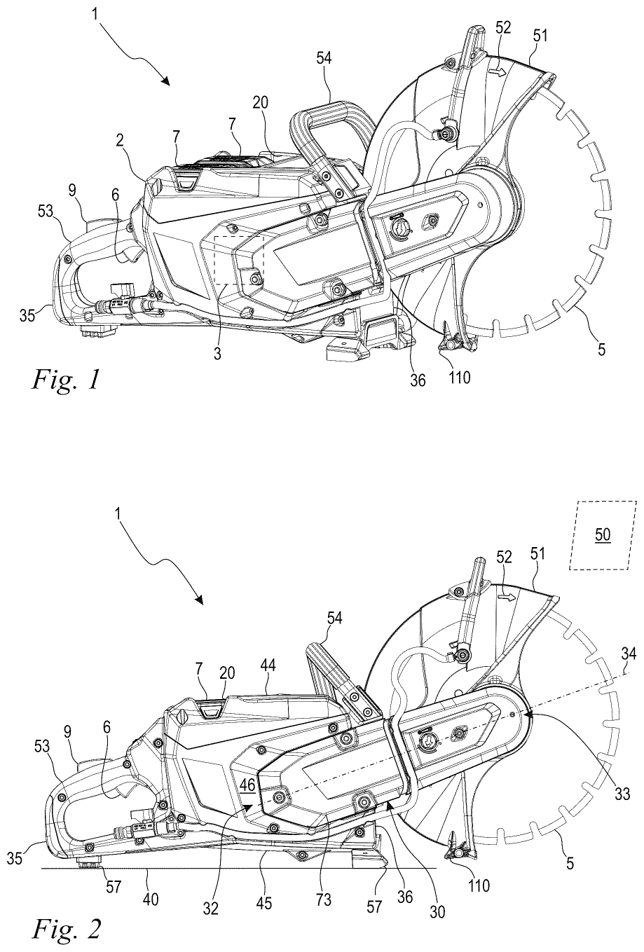

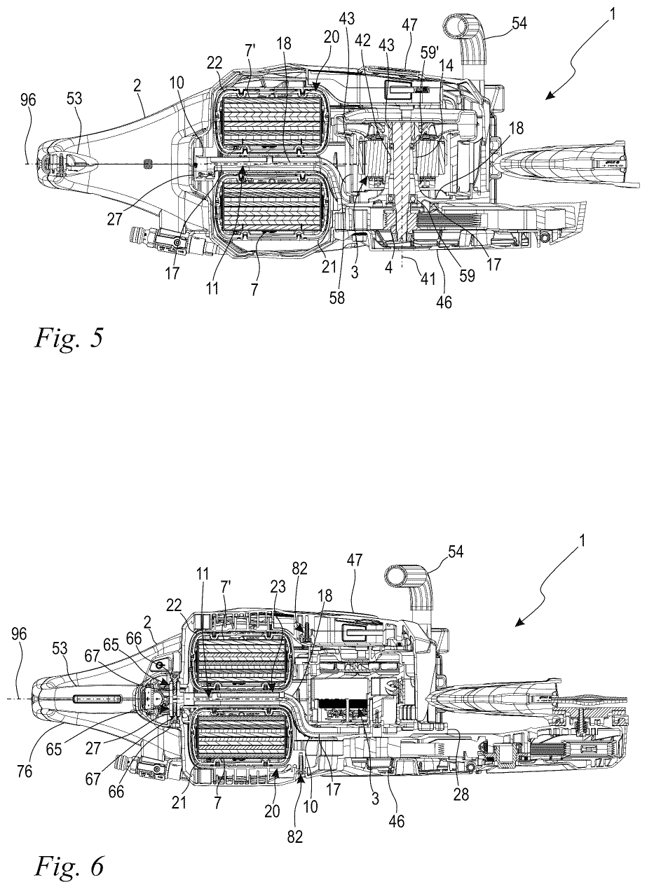

FIG. 1 shows an exemplary embodiment of the handheld work apparatus 1 as a cut-off machine. The work apparatus 1 can alternatively also be designed as a chainsaw or as another work apparatus. The work apparatus 1 is handheld, in particular hand-carried. The work apparatus 1 is carried and guided by the operator during operation. The work apparatus 1 has a housing 2. Furthermore, the work apparatus 1 comprises a drive motor 3 (FIG. 5), the drive motor 3 being arranged in the housing 2. In FIG. 1, the drive motor 3 is shown merely schematically by way of a dashed square. In the present exemplary embodiment, the drive motor 3 is an electric motor. In an alternative embodiment, the drive motor 3 could also be an internal combustion engine. The drive motor 3 is used for driving a tool 5 that can be arranged on the work apparatus 1. In the present exemplary embodiment, the tool 5 is a cutting wheel.

As shown in FIGS. 5 and 6, the work apparatus 1 comprises at least one battery pack 7 for supplying the drive motor 3 with electrical power. Particularly preferably, the work apparatus 1 comprises a further battery pack 7′ for supplying the drive motor 3 with power. A receptacle housing 20 is provided for receiving the at least one battery pack 7 and/or the further battery pack 7′. The receptacle housing 20 is arranged on the housing 2, in particular fixed thereon. In the present embodiment of the work apparatus 1, the receptacle housing 20 is designed as a component that is separate from the housing 2. In an alternative embodiment, it can also be provided that the receptacle housing 20 and the housing 2 are designed as a single piece, in particular the receptacle housing 20 is an integral part of the housing 2. The receptacle housing 20 comprises a first receptacle 21 for receiving the at least one battery pack 7. Furthermore, the receptacle housing 20 comprises a second receptacle 22 for receiving the further battery pack 7′. The battery packs 7, 7′ can be removed from the receptacle housing 20, in particular the receptacles 21, 22, without using tools. To attach the battery packs 7, 7′ to the work apparatus 1, they are inserted into the receptacle housing 20, in particular into the receptacles 21, 22, and clipped into place. This clip attachment can be released without using tools and the battery packs 7, 7′ can be removed from the receptacle housing 20, in particular from the receptacles 21, 22, again, for example for charging or simply to replace them. The battery packs 7, 7′ can alternatively be designed as slide-in battery packs.

As shown in FIGS. 1 and 2, the work apparatus 1 comprises a rear handle 53. Furthermore, the work apparatus 1 comprises a front handle 54. The front handle 54 is preferably designed as a handle tube. Other configurations of the front handle 54 can also be expedient. The housing 2 extends from a rear end 35 up to a front end 36. The rear handle 53 forms in the present case the rear end 35 of the housing 2. In an alternative embodiment, it can also be provided that the rear handle 53 is designed separately from the housing 2. In such an embodiment, the rear handle 53 is arranged in the region of the rear end 35 of the housing 2. The front handle 54 is arranged in the region of the front end 36 of the housing 2.

In addition, the work apparatus 1 has a control element 6, the control element 6 being provided for controlling the drive motor 3. The control element 6 is designed as an operating lever. The control element 6 is assigned to the rear handle 53. Furthermore, the work apparatus 1 comprises a blocking element 9, which locks the control element 6 in a blocking position and releases the control element 6 for actuation in an enable position. The blocking element 9 is preferably designed as a blocking lever. The blocking as well as the enable function performed by the blocking element 9 can take place mechanically and/or electronically, for example by means of sensors. The blocking element 9 is assigned to the rear handle 53. This means that when the operator grips the rear handle 53, they can actuate the control element 6 as well as the blocking element 9. In the preferred exemplary embodiment, the control element 6 and the blocking element 9 are arranged on the rear handle 53.

Particularly preferably, the work apparatus 1 comprises a control unit, not shown in more detail. The control unit processes signals that are generated by the control element 6 and/or the blocking element 9 and is mainly used for controlling the drive motor 3. Other functions of the work apparatus 1 can also be implemented via the control unit.

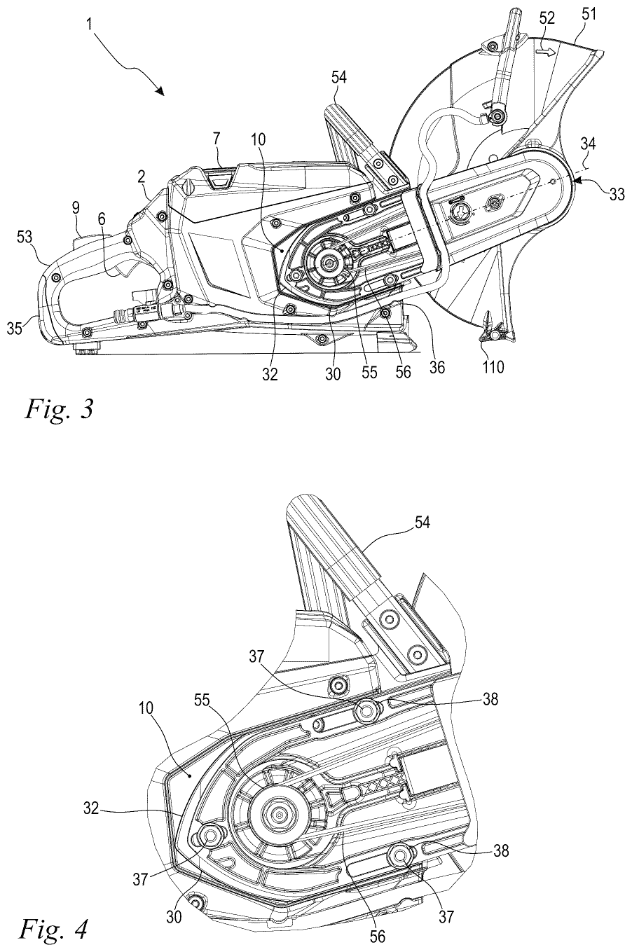

As shown in FIG. 3, the work apparatus 1 comprises an arm 30. The arm 30 extends along its longitudinal centre axis 34 from a proximal end 32 up to a distal end 33. The arm 30 is at least indirectly secured to the housing 2. The arm 30 is secured indirectly to the housing 2 in particular in the region of the front end 36 of the housing 2. The arm 30 protrudes beyond the front end 36 of the housing 2 and extends with its distal end 33 away from the front end 36 of the housing 2. The tool 5 can be arranged on the distal end 33 of the arm 30. The tool 5 is rotatably mounted on the distal end 33 of the arm 30. When the work apparatus 1 is in operation, the tool 5 is driven in rotation by the drive motor 3 in a direction of rotation 52 (FIGS. 1 and 3).

As shown in FIGS. 3 and 4, the work apparatus 1 comprises a pulley 55 that is driven via the drive motor 3. Furthermore, the work apparatus 1 comprises a further pulley (not shown in more detail) that is arranged at the distal end 33 of the arm 30 and is fixedly connected to the tool 5 in the direction of rotation 52 of the tool 5. Of course, the tool 5 as well as the further pulley can be detached, whereby they can each be replaced individually. The pulley 55, which is preferably arranged in the region of the proximal end 32 of the arm 30 on the housing 2, is operatively connected to the further pulley via a belt 56. The belt 56 is used for transmitting speed and torque between the drive motor 3 and the tool 5.

As shown in FIGS. 1 and 2, the work apparatus 1 comprises a protective hood 51. The protective hood 51 is attached to the arm 30, in particular to the distal end 33 of the arm 30. The protective hood 51 covers part of the circumference of the tool 5.

As shown in FIG. 2, the work apparatus 1 comprises a top side 44 and a bottom side 45, wherein the bottom side 45 of the work apparatus 1 can be set down on a floor 40. The top side 44 and the bottom side 45 are connected to one another by a first longitudinal outer side 46 and a second longitudinal outer side 47. Expressions which describe the sides or other components of the work apparatus 1 in terms of space, for example “top side” and “bottom side”, refer in principle in this case to the usual set-down position of the work apparatus 1 shown in FIG. 2. The usual set-down position of the work apparatus 1 is a position in which the work apparatus 1 is set down on a flat, horizontal set-down surface. Feet 57 are used for setting down the work apparatus 1.

As shown in FIGS. 5 to 7, the work apparatus 1 comprises a motor support unit 10. The motor support unit 10 is designed separately from the housing 2. The drive motor 3 is preferably attached to the motor support unit 10 directly. The housing 2 is likewise attached to the motor support unit 10.

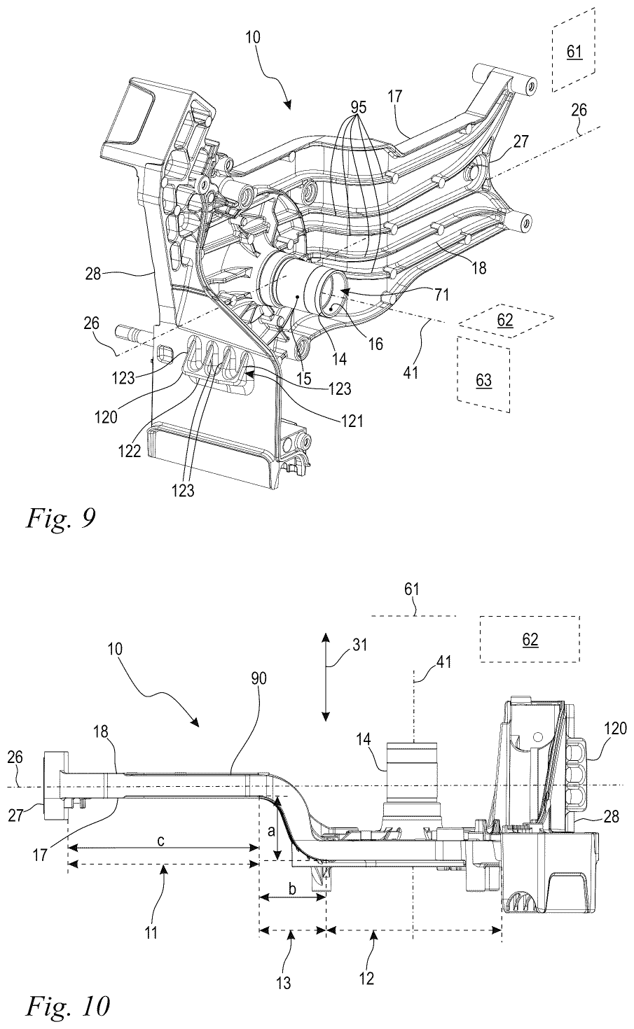

As shown in FIGS. 8 and 9, the motor support unit 10 is designed as a motor support plate. The motor support unit 10 has a longitudinal extent. The motor support unit 10 comprises a rear end 27 and a front end 28. The rear handle 53 is arranged on the rear end 27 of the motor support unit 10. The front handle 54 is arranged on the front end 28. The motor support unit 10 has a longitudinal centre axis 26 which extends from the rear end 27 of the motor support unit 10 up to the front end 28 of the motor support unit 10. The longitudinal centre axis 26 lies in a longitudinal plane 61 of the motor support unit 10. The longitudinal plane 61 is aligned parallel to the tool plane 50. In an alternative embodiment of the work apparatus 1 it can also be provided that the longitudinal plane 61 of the motor support unit 10 corresponds to the tool plane 50.

As shown in FIG. 9, the motor support unit 10 comprises a motor receptacle 14, which in the present embodiment is designed in particular as a hollow tube. The motor receptacle 14, in particular the hollow tube, has an outer side 15 and an inner side 16. The drive shaft 4 of the drive motor 3 is mounted in the hollow tube so as to rotate about an axis of rotation 41 (FIG. 5).

As shown in FIG. 5, comprises the drive motor 3 designed as an electric motor comprises a stator 42 and a rotor 43. The stator 42, which comprises a plurality of coils, is arranged on the outer side 15 of the hollow tube, in particular directly. The rotor 43 comprises in turn the drive shaft 4 and a rotor section 58 extending over the stator 42. The rotor section 58 is provided with corresponding permanent magnets which interact with the coils of the stator 42. The rotor section 58 and the drive shaft 4 are connected to one another in a rotationally fixed manner. The rotor 43 is mounted via its drive shaft 4 by means of two bearings 59, 59′ on the inner side 16 of the hollow tube such that it can rotate relative to the latter. The electric motor is designed in the present case as an outrunner. In an alternative embodiment of the work apparatus 1, it can also be expedient to design the electric motor as an inrunner.

As shown in FIG. 9, the axis of rotation 41 of the drive shaft 4 is aligned somewhat perpendicular to the longitudinal plane 61 of the motor support unit 10. The axis of rotation 41 lies within a vertical plane 63 of the motor support unit 10. The vertical plane 63 of the motor support unit 10 is aligned perpendicular to the longitudinal centre axis 26, in particular perpendicular to the longitudinal plane 61. Furthermore, the motor support unit 10 has a transverse plane 62 aligned perpendicular to the vertical plane 63 and perpendicular to the longitudinal plane 61.

As shown in FIGS. 8 and 10, the motor support unit 10 has a first longitudinal section 11, a second longitudinal section 12 and a middle section 13. The middle section 13 is provided between the first longitudinal section 11 and the second longitudinal section 12. The first longitudinal section 11 and the second longitudinal section 12 are preferably connected to one another via the middle section 13. The mentioned sections divide the motor support unit 10 in the direction of the longitudinal centre axis 26. The first longitudinal section 11 extends from the rear end 27 of the motor support unit 10 up to the middle section 13 of the motor support unit 10. The middle section 13 of the motor support unit 10 extends from the first longitudinal section 11 of the motor support unit 10 up to the second longitudinal section 12 of the motor support unit 10. The second longitudinal section 12 of the motor support unit 10 extends from the middle section 13 of the motor support unit 10 up to the front end 28 of the motor support unit 10.

As shown in particular in FIG. 10, the middle section 13 is approximately Z-shaped in a plan view of the motor support unit 10, i.e. in a direction perpendicular to the transverse plane 62 of the motor support unit 10. The middle section 13 has a first curvature 91 and a second curvature 92, wherein the first curvature 91 and the second curvature 92 run in opposite directions to each other. Due to the arrangement of these two curvatures 91, 92 relative to each other, the middle section 13 has the approximately Z-shaped contour. The first curvature 91 has a first axis of curvature 93. The second curvature 92 has a second axis of curvature 94. The first axis of curvature 93 of the first curvature 91 and the second axis of curvature 94 of the second curvature 92 are aligned parallel to one another. The motor support unit 10 is thus only curved once. The first axis of curvature 93 of the first curvature 91 and the second axis of curvature 94 of the second curvature 92 are aligned perpendicular to the transverse plane 62.

The first longitudinal section 11 and the second longitudinal section 12 are aligned substantially parallel to one another. Due to the opposite curvatures 91, 92 of the middle section 13 of the motor support unit 10, the first longitudinal section 11 and the second longitudinal section 12 are arranged offset from one another in the direction perpendicular to the longitudinal plane 61 of the motor support unit 10. The motor support unit 10 has a first outer side 17 and a second outer side 18. The middle section 13 of the motor support unit 10 has an offset width a which is measured in the direction perpendicular to the longitudinal plane 61 of the motor support unit 10 on the first outer side 17 of the motor support unit 10. The offset width a corresponds to the maximum distance measured in the direction perpendicular to the longitudinal plane 61 between the respective transition regions of the middle section 13 and the first longitudinal section 11 and, respectively, second longitudinal section 12 on the first outer side 17. Furthermore, the middle section 13 of the motor support unit 10 has a length b, measured in the direction of the longitudinal centre axis 26, which corresponds to the distance between the first longitudinal section 11 and the second longitudinal section 12. The offset width a of the middle section 13 of the motor support unit 10 corresponds to at least 50%, preferably at least 70%, in particular at least 90% of the length b of the middle section 13 of the motor support unit 10. Furthermore, the first longitudinal section 11 has a length c, measured in the direction of the longitudinal centre axis 26, which corresponds to the distance between the rear end 27 and the middle section 13. The offset width a of the middle section 13 of the motor support unit 10 corresponds to at least 10%, in particular at least 20% of the length c of the first middle section 11 of the motor support unit 10.

As mentioned above, the motor support unit 10 is curved once. This configuration of the motor support unit 10 enables, in addition to the spatial designs in the housing interior, also the formation of a main demoulding direction 31. This also corresponds to the direction of the axis of rotation 41. This in turn enables the motor receptacle 14 to be configured in the form of a hollow tube. The housing interior is delimited by the housing 2. Components with a single curvature can be moulded and demoulded significantly more easily than components with two curvatures. The tools required for this can have a simpler design.

As shown in FIGS. 6 and 8, the work apparatus 1 comprises first attachment units 65, which are provided for attaching the housing 2 to the motor support unit 10. Each first attachment unit 65 comprises a first fastener 66, designed in the present case as a screw, and a first attachment receptacle 67, which is designed as an opening with an internal thread for receiving the screw. At least one first attachment receptacle 67, in the present case four first attachment receptacles 67, is provided at the rear end 27 of the motor support unit 10. Furthermore, further first attachment receptacles 67 are provided in the middle section 13 of the motor support unit 10 and on the front end 28 of the motor support unit 10 for connecting the housing 2 to the motor support unit 10. At least one first attachment receptacle 67 is preferably also arranged on the second longitudinal section 12 of the motor support unit 10. By contrast, the first longitudinal section 11 of the motor support unit 10 is free of first attachment units 65, in particular of first attachment receptacles 67.

As shown in FIGS. 5 and 6, the drive motor 3 is attached in the second longitudinal section 12 of the motor support unit 10. The drive motor 3 is arranged substantially on the second outer side 18 of the motor support unit 10. The motor receptacle 14 is also provided on the second outer side 18 of the motor support unit 10.

As shown in particular in FIG. 8, the motor support unit 10 comprises an attaching section 19. The attaching section 19 is used for attaching a component to the motor support unit 10, with the tool 5 being held in turn on the component. In the present embodiment of the work apparatus 1, the attaching section is provided for attaching the arm 30 to the motor support unit 10. If the work apparatus 1 is a chainsaw, the attaching section 19 is preferably provided for attaching a guide bar thereto. The chainsaw chain would then be guided as a tool on the guide bar. The attaching section 19 is provided on the first outer side 17 of the arm 10. The attaching section 19 extends in the present exemplary embodiment from the middle section 13 via the second longitudinal section 12 up to the front end 28 of the motor support unit 10. In the region of the attaching section 19, multiple, in the present case three, stud bolts 37 are arranged on the motor support unit 10, in particular screwed into the motor support unit 10. The arm 10 rests, as shown in FIGS. 3 and 4, on the attaching section 19 of the motor support unit 10, and is fastened via the stud bolt 37 and the associated nuts 38 to the motor support unit 10. If the nuts 38 have been loosened, the arm 30 can be displaced in its longitudinal direction 34. The tension of the belt 56 can thus be adjusted. The stud bolts 38 attached in the motor support unit 10 pass through openings on the arm 30, which are designed as elongate holes so that the arm 30 can be displaced relative to the motor support unit 10.

Furthermore provided on the motor support unit 10 is a central opening 71 (FIGS. 8 and 9) which is part of the motor receptacle 14, in particular part of the hollow tube. The drive shaft 4 of the drive motor 3 projects through the central opening 71. The drive shaft 4 projects from the second outer side 18 of the motor support unit 10 through the central opening 71 onto the first outer side 17 of the motor support unit 10. Furthermore, the drive shaft 4 also projects through an opening in the arm 10. Arranged at the end of the drive shaft 4, which is located on the first outer side 17 of the motor support unit 10, is the pulley 55, which drives the belt 56. The arm 30 is covered by a cover 73. Moreover, the cover 73 also covers the pulley 55 as well as the belt 56.

As shown in FIG. 6, the housing 2 is attached to the rear end 27 of the motor support unit 10 by means of the attachment units 65. The housing 2 is formed from a handle housing 76 in this region. The handle housing 76 is attached via the attachment units 65 to the rear end 27 of the motor support unit 10. The rear handle 53 is formed on the handle housing 76. The actuating element 6 and the blocking element 9 are arranged on the rear handle 53.

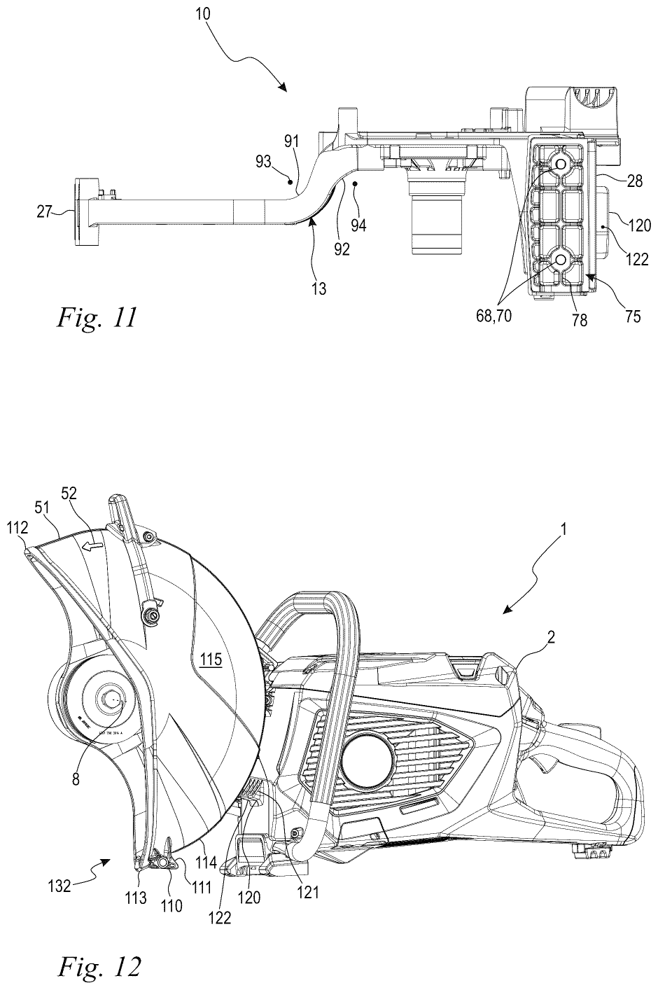

Second attachment units 68, in particular second attachment receptacles 70, are provided on the motor support unit 10 for attaching the front handle 54 to the motor support unit 10. As shown in particular in FIGS. 8 and 11, the second attachment units 68 are provided on the front end 28 of the motor support unit 10. Positioning the attachment units 68 at least partially differently, for example in the second longitudinal section 12 of the motor support unit 10, may also be expedient.

A first, upper handle receptacle 74 is arranged, in particular formed, on the motor support unit 10. The upper handle receptacle 74 is preferably an integral constituent part of the motor support unit 10. The first, upper handle receptacle 74 is used for mounting and attaching the front handle 54. The first, upper handle receptacle 74 of the motor support unit 10 is arranged in the region of the top side 44 of the work apparatus 1 as well as in the region of the first longitudinal outer side 46 of the work apparatus 1. The first, upper handle receptacle 74 has an approximately semi-cylindrical contour 77, in which the front handle 54 comes to rest. The front handle 54 is designed as a handle tube. Of course, the geometry of the handle tube as well as the contour 77 of the upper handle receptacle 74 are matched to each other. In the present exemplary embodiment, the handle tube is cylindrical and so the contour 77 is also semi-cylindrical. Other geometries of the handle tube as well as the contour 77 of the first, upper handle receptacle 74 can also be expedient, provided these are matched to each other.

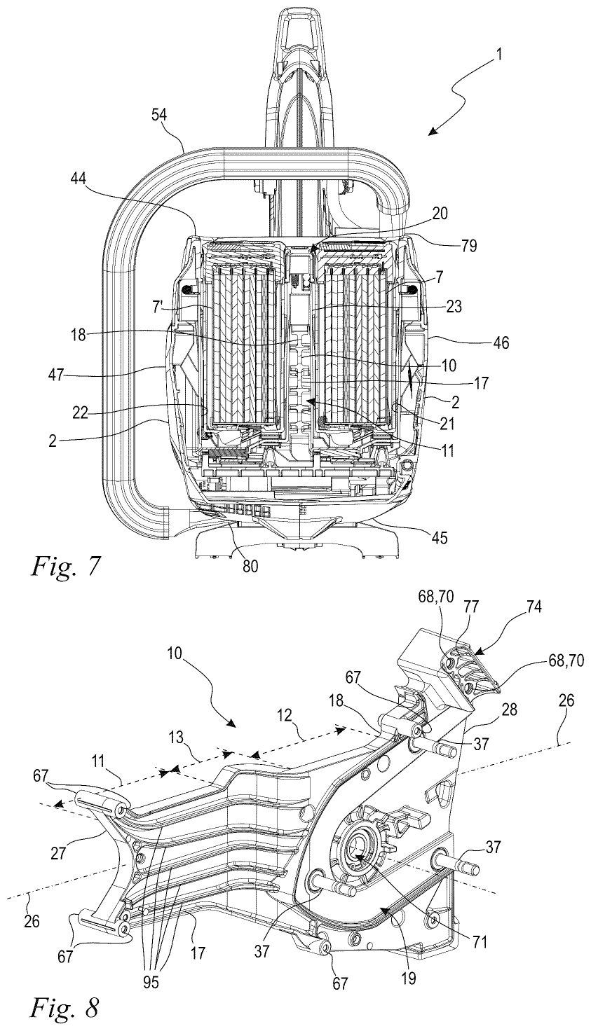

At least one second attachment receptacle 70, preferably two second attachment receptacles 70 are formed in the first, upper handle receptacle 74. The second attachment receptacles 70 are preferably formed as openings, each with an internal thread, whereby the front handle 54 can be screwed to the first, upper handle receptacle 74 using screws as fasteners 69. As shown in FIG. 7, the handle 54 extends from one end 79 to another end 80. Preferably, the one end 79 of the front handle 54 is attached to the first, upper handle receptacle 74 of the motor support unit 10.

A second, lower handle receptacle 75 is arranged, in particular formed, on the motor support unit 10 (FIG. 11). The second, lower handle receptacle 75 is preferably an integral part of the motor support unit 10. The second, lower handle receptacle 75 is used for mounting and attaching the front handle 54. The second, lower handle receptacle 75 of the motor support unit 10 is arranged in the region of the bottom side 45 of the work apparatus 1. Just like the first, upper handle receptacle 74, the second, lower handle receptacle 75 has an approximately semi-cylindrical contour 78, in which the front handle 54 comes to rest. At least one second attachment receptacle 70, preferably two second attachment receptacles 70, are formed in the second, lower handle receptacle 75. The front handle 54 can be screwed to the second, lower handle receptacle 75 using screws as fasteners 69. Preferably, the other end 80 of the front handle 54 is attached to the second, lower handle receptacle 75 of the motor support unit 10.

As shown in FIG. 7, the front handle 54, in particular the handle tube, runs from the first, upper handle receptacle 74 via the top side 44 to the second longitudinal outer side 47 of the work apparatus 1. From there, the front handle 54, in particular the handle tube, extends along the second longitudinal outer side 47 to the bottom side 45 of the work apparatus 1 and ends in the second, lower handle receptacle 75 on the bottom side 45 of the work apparatus 1. The front handle 54 is only attached to the motor support unit 10 via its two ends 79, 80. In the region between its two ends 79, 80, the front handle 54 is arranged spaced apart from the housing 2 of the work apparatus 1, so that the operator can grasp the front handle 54.

In an alternative embodiment of the work apparatus 1, it can also be provided that the first, upper handle receptacle 74 is arranged in a different place. For instance, the first, upper handle receptacle 74 can alternatively be integrated in the attaching section 19 of the motor support unit 10. In such an embodiment, the first, upper handle receptacle 74 would be arranged substantially on the first longitudinal outer side 46. Other positions are also conceivable. However, it is particularly advantageous that both the first, upper handle receptacle 74 and the second, lower handle receptacle 75 are formed directly on the motor support unit 10. The front handle 54 is thus attached directly to the motor support unit 10. The rear handle 53, in particular the handle housing 76, is also attached directly to the motor support unit 10. Particularly preferably, no separately formed antivibration element is provided between the front handle 54 and the motor support unit 10. Preferably, no separately formed antivibration element is provided between the rear handle 53 and the motor support unit 10 either. Since, in the present embodiment, the drive motor 3 is an electric motor, there is no need for vibration decoupling between the drive motor 3 and the front handle 54 as well as the rear handle 53.

As shown in FIGS. 5 to 7, the receptacle housing 20, in which the at least one battery pack 7 and/or the further battery pack 7′ are arranged, is arranged in the longitudinal section 11 of the motor support unit 10. The receptacle housing 20 thus lies, relative to the longitudinal direction 26 of the motor support unit 10, between the rear end 27 of the motor support unit 10 and the middle section 13 of the motor support unit 10. The first receptacle 21 of the receptacle housing 20 and the second receptacle 22 of the receptacle housing 20 are arranged separated from each other by the longitudinal section 11 of the motor support unit 10. In other words, the receptacle 21 and the receptacle 22 are arranged opposite each other in relation to the first longitudinal section 11 of the motor support unit 10. The first receptacle 21 of the receptacle housing 20 is arranged facing the first outer side 17 of the motor support unit 10, in particular in the first longitudinal section 11 of the motor support unit 10. The second receptacle 22 of the receptacle housing 20 is arranged facing the second outer side 18 of the motor support unit 10. The motor support unit 10 thus runs between the two receptacles 21, 22 of the receptacle housing 20, in particular between the two battery packs 7, 7′.

The receptacle housing 20, comprising the first receptacle 21 and the second receptacle 22, is preferably designed as a single piece. The receptacle housing 20 has an opening 23 which extends in the direction of the longitudinal centre axis 26 of the motor support unit 10. The motor support unit 10 can thus be arranged in the opening 23 of the receptacle housing 20. The opening 23 is open towards the bottom, i.e. towards the bottom side 45 of the work apparatus 1. The first receptacle 21 of the receptacle housing 20 and the second receptacle 22 of the receptacle housing 20 are separated from one another by the opening 23. Due to this arrangement of the motor support unit 10 and the receptacle housing 20, the motor support unit 10 is arranged at least partially centrally in the housing 2 of the work apparatus 1, whereby this evenly supports and braces the housing 2 via the first attachment units 65. Due to the arrangement of the two battery packs 7, 7′ and of the two receptacles 21, 22 of the receptacle housing 20 each on one outer side 17, 18 of the motor support unit 10, a compact design of the work apparatus 1 can simultaneously be ensured.

As shown in FIGS. 5 to 7, the receptacle housing 20 is attached only to the housing 2. By contrast, there is no direct attachment between the receptacle housing 20 and the motor support unit 10. The housing 2 has a certain degree of flexibility, which permits relative movement of the receptacle housing 20 with respect to the motor support unit 10. Moreover, the receptacle housing 20 and the motor support unit 10 are arranged spaced apart from each other. This can ensure that in the event of a desired relative movement between the receptacle housing 20 and the motor support unit 10, mutual jamming of the components can be prevented. Particularly preferably, the motor support unit 10 is free of contact with respect to the receptacle housing 20 over its entire first longitudinal section 11. Third attachment units 82 are provided for attaching the receptacle housing 20 to the housing 2. The attachment units 82 are preferably formed from screw connections.

The motor support unit 10 is preferably a moulded part. The motor support unit 10 is formed in particular from a material that has a higher modulus of elasticity than the material of the housing 2. The motor support unit 10 is preferably formed from a metal alloy, in particular from a magnesium alloy. The housing 2 is preferably formed from a plastic. The housing 2 is designed such that it has sufficient strength to protect the components arranged within the housing 2. At the same time, the housing 2 has an elasticity that absorbs corresponding inertial forces of the battery packs 7, 7′ in the event that the work apparatus 1 makes sudden impact with the ground or other objects, so that the forces transmitted from the receptacle housing 20 via the housing 2 to the motor support unit 20 are damped accordingly.

The receptacle housing 20, the motor support unit 10 and the housing 2 are arranged and designed in relation to each other such that if the work apparatus 1 collides with an object or similar, a force that is generated by the inertia of the battery packs 7, 7′ arranged in the receptacle housing 20 cannot flow directly from the receptacle housing 20 to the motor support unit 10. The force emanating from the battery packs 7, 7′ flows via the receptacle housing 20 into the housing 2 and from the housing 2 into the motor support unit 10. As a result of elastic and/or plastic deformation of the housing 2, the energy is converted in the housing 2 by deformation. The resulting impact load acting on the motor support unit 10 is thus significantly reduced, whereby damage to the motor support unit 10 can be prevented.

As shown in FIG. 10, the motor support unit 10 comprises a base body 90, which extends from the first longitudinal section 11 via the middle section 13 up to and including the second longitudinal section 12. This base body 90 has a single curve made by the Z-shaped contour of the middle section 13. The motor receptacle 14 is arranged on the base body 90 of the motor support unit 10. The first longitudinal section 11 of the motor support unit 10 lies centrally in the housing interior (FIGS. 5 to 7). The rear handle 6 has a longitudinal centre axis 96, wherein, in a plan view of the work apparatus, i.e. when viewed in the direction of the transverse plane 62, the longitudinal centre axis 96 of the rear handle 6 lies in the first longitudinal section 11 of the motor support unit 10. As a result, the first longitudinal section 11 of the motor support unit 10 divides the housing interior in the region of the longitudinal section 11 into two equally sized smaller installation spaces, in each of which a receptacle 21, 22 of the receptacle housing 20 is arranged. The second longitudinal section 12 of the motor support unit 10 lies outside the longitudinal centre axis 96 of the rear handle 6. The distance between the second longitudinal section 12 of the motor support unit 10 and the first longitudinal outer side 46 of the work apparatus 1 is less than the distance between the first longitudinal section 11 of the motor support unit 10 and the first longitudinal outer side 46 of the work apparatus 1. As a result, the installation space in the region of the second longitudinal section 12 of the motor support unit 10 towards the second longitudinal outer side 47 is significantly bigger than the two smaller installations spaces in the region of the first longitudinal section 11 of the motor support unit 10.

As shown in FIGS. 8 and 9, the motor support unit 10 comprises at least one stiffening rib 95, in the present case multiple stiffening ribs 95. The stiffening ribs 95 run substantially in direction of the longitudinal centre axis 26 of the motor support unit 10. The stiffening ribs 95 are formed on both the first outer side 17 and on the second outer side 18. The stiffening ribs 95 run at least from the first longitudinal section 11 up to the middle section 13. In the present case, the stiffening ribs 95 run on the first outer side 17 of the motor support unit 10 from the rear end 27 of the motor support unit 10 over the first longitudinal section 1 of the motor support unit 10 and to the middle section 13 of the motor support unit 10. On the second outer side 18 of the motor support unit 10, the stiffening ribs 95 run from the rear end 27 of the motor support unit 10 over the first longitudinal section 11 of the motor support unit 10, over the middle section 13 of the motor support unit 10 and to the second longitudinal section 12 of the motor support unit 10. The stiffening ribs 95 are preferably free of interruption in the direction of the longitudinal centre axis 26 of the motor support unit 10.

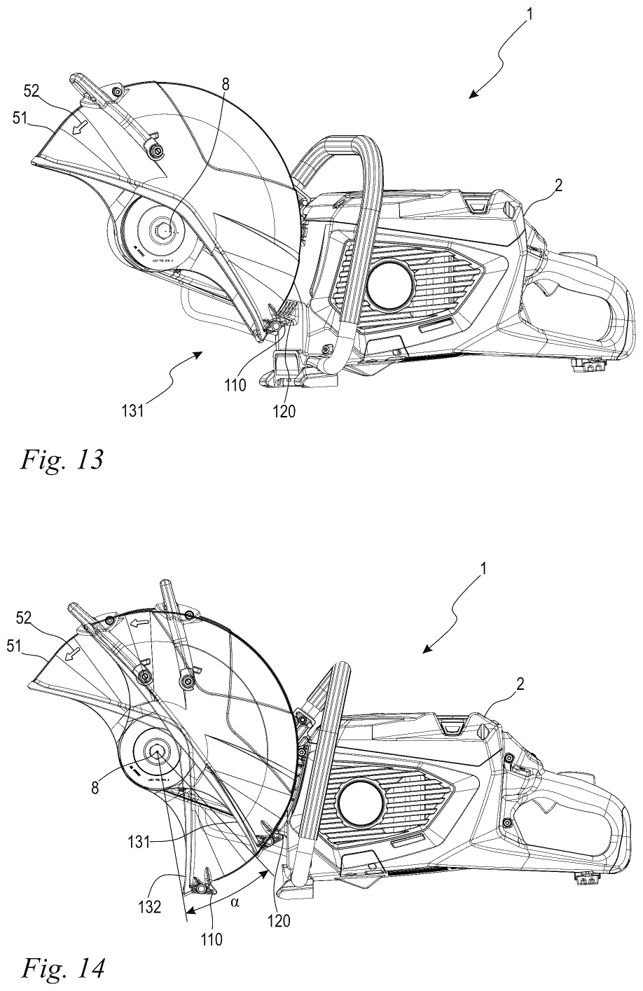

As shown in FIGS. 12 and 13, the work apparatus 1 comprises a stop 110. The stop 110 is arranged on the protective hood 51 of the work apparatus 1. Furthermore, the work apparatus 1 comprises a mating stop 120. The mating stop 120 is formed on the motor support unit 10. The stop 110 and the mating stop 120 are designed to interact mechanically in order to limit a pivoting movement of the protective hood 51 to an end position 131. The tool 5 is mounted so as to rotate about an axis of rotation 8. The protective hood 51 is mounted so as to pivot about an axis of rotation. The axis of rotation of the protective hood 51 corresponds to the axis of rotation 8 of the tool 5. The protective hood 51 can be pivoted from an open position 132, as is shown in FIG. 12, into the end position 131. In FIG. 13, the protective hood 51 of the work apparatus 1 is shown in the end position 131. The stop 110 of the protective hood 51 and the mating stop 120 of the motor support unit 10 make contact in this end position 131.

As shown in FIG. 14, the protective hood 51 is able to pivot about a maximum pivot angle α. The maximum pivot angle α extends, in relation to the axis of rotation 8, from the open position 132 into the end position 131. It is not possible for the protective hood 51 to pivot in the direction of rotation 52 of the tool 5 beyond the end position 131. It is not possible for the protective hood 51 to pivot counter to the direction of rotation 52 of the tool 5 beyond the open position 132. The maximum pivot angle α is preferably less than or equal to 90°, in particular less than 60°. The maximum pivot angle α of the protective hood 51 from the open position 132 to the end position 131 or from the end position 131 to the open position 132 is preferably at least 30°.

As shown in FIG. 12, the protective hood 51 extends from a first end 112 about the axis of rotation 8 up to a second end 113. The second end 113 is the end of the protective hood 51 which, both in the end position 131 and in the open position 132 of the protective hood 51, is arranged closer to the housing 2, preferably closer to the motor support unit 10. Moreover, the second end 113 lies below the first end 112 of the protective hood 51. The stop 110 is preferably arranged adjacent to the end 113 of the protective hood 51. The protective hood 51 has a first longitudinal side 115, a second longitudinal side 116 as well as a peripheral side 114. The first longitudinal side 115 and the second longitudinal side 116 are connected to one another via the peripheral side 114. The main direction of extension of the first longitudinal side 115 and the second longitudinal side 116 of the protective hood 51 runs approximately parallel to the tool plane 50. The stop 110 is arranged on the peripheral side 114 of the protective hood 51.

The stop 110 is preferably integral with the protective hood 51. The protective hood 51 is preferably a moulded component. The protective hood 51 and the stop 110 are preferably formed from a single moulded component. The protective hood 51 as well as the stop 110 are formed in particular from a metal alloy. Thus, the protective hood 51 together with the stop 110 has a high component strength. In an alternative embodiment, it can also be provided that the protective hood 51 is welded from sheet metal elements.

As shown in particular in FIGS. 9 to 11, the mating stop 120 is arranged on the front end 28 of the motor support unit 10. Particularly preferably, the mating stop 120 is integral with the motor support unit 10. As already mentioned above, the motor support unit 10 is designed in the preferred embodiment as a moulded component. Therefore, the motor support unit 10 as well as the mating stop 120 form a single moulded component. The motor support unit 10 as well as the mating stop 120 consist preferably of a metal alloy, in particular of a magnesium alloy.

As shown in FIGS. 12 to 16, the work apparatus 1 comprises a first stop surface 111 and a second stop surface 122. The first stop surface 111 is formed on the stop 110 of the protective hood 51. The second stop surface 122 is formed on the mating stop 120 of the motor support unit 10. In the end position 131 of the protective hood 51, the stop 110 lies with the first stop surface 111 on the second stop surface 122 of the mating stop 122. In the end stop 131 of the protective hood 51, the first stop surface 111 and the second stop surface 122 make contact with each other in a contact surface 130. The first stop surface 111 and the second stop surface 122 are therefore designed in such a way that they make full area contact with each other in the end position 131 of the protective hood 51.

FIG. 16 shows an enlarged view of the stop 110 and the mating stop 120 in mutual contact. The contact surface 130 spans a contact plane 140. The tool 5 is shown in FIG. 16 as a dashed line and has a tool circumference 141. The fact that such a tool 5, in the form, for example, of a cutting wheel, does not have an ideally circular tool circumference should be understood as meaning a, in relation to the axis of rotation 8 of the tool 5, radially outermost contour of a rotary body specified by the tool 5. The contact plane 140 intersects the tool 5 at the tool circumference 141 of the tool 5 at a contact line that is not shown in more detail. At this contact line, the tool 5 has a tangent plane 142. In other words, the tool 5 has a tangent plane 142 that is tangent to the tool 5 at the tool circumference 141 at the mentioned contact line. Contact plane 140 and tangent plane 142 intersect at the contact line, thereby making an angle β. The angle β is open in relation to the contact line in the direction of rotation 52 of the tool 5. The angle β is preferably less than 90°, in particular less than 80°. The angle β is in particular more than 60°, in particular more than 70°. The angle β is selected such that the stop and the mating stop hook into each other. The protective hood 51 is pulled towards the motor support unit 10 by the above-described angular alignment of the contact zone when stop 110 and end stop 120 come into contact. Nevertheless, the angle β is not so acute that the attraction forces of stop 110 and mating stop 120 are so high that the stop 110 breaks out of the protective hood 51 or the mating stop 120 breaks out of the motor support unit 10.

As shown in particular in FIG. 9, the mating stop 120 has a load transfer structure 121. The load transfer structure 121 extends starting from the second stop surface 122 tangentially to the direction of rotation 52 of the tool in the base body 90 of the motor support unit (FIG. 14). The mating stop 120 has multiple ribs 123 which are parts of the load transfer structure 121. In the preferred embodiment of the work apparatus 1, the mating stop 120 comprises two outer ribs 123 which limit the mating stop 120 in the direction of the axis of rotation 8 of the tool 5, i.e. in the width of the mating stop. Arranged between the two outer ribs 123 is at least one further rib, preferably two ribs or more. On the one hand, this provides a sufficient support structure that enables a high transmission of force from the stop 110 of the protective hood 51 via the mating stop 120 to the base body 90 of the motor support unit 10. On the other hand, the ribbed load transfer structure is conducive to manufacturing the mating stop 120 as a moulded component.

As shown in FIG. 16, the first stop surface 111 on the stop 110 of the protective hood 51 is aligned in the direction of rotation 52 of the tool 5. The second stop surface 122 on the mating stop 120 of the motor support unit 10 is aligned counter to the direction of rotation 52 of the tool 5.

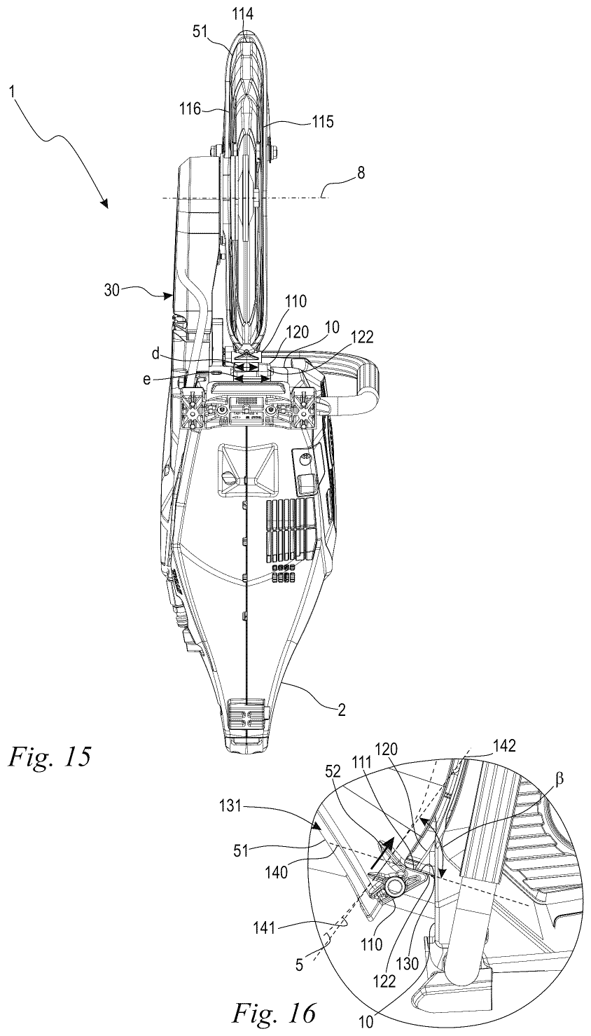

As shown in FIG. 15, the first stop surface 111 of the stop 110 has a width d measured in the direction of the axis of rotation 8 of the tool 5. The second stop surface 122 of the mating stop 120 has a width e measured in the direction of the axis of rotation 8 of the tool 5. The width e of the second stop surface 122 of the mating stop 120 is more than the width d of the first stop surface 111 of the stop 110. The width e of the second stop surface 122 of the mating stop 120 corresponds to at least 1.2 times, preferably at least 1.3 times, in particular at least 1.4 times the width d of the first stop surface 111 of the stop 110 of the protective hood 51. Particularly preferably, the width e of the second stop surface 122 of the mating stop 120 corresponds to approximately 1.5 times the width d of the first stop surface 111 of the stop 110 of the protective hood 51. The width d of the first stop surface 111 of the stop 110 is less than the width of the base body of the protective hood 51, which is specified by the distance, measured in the direction of the axis of rotation 8 of the tool 5, between the first longitudinal side 115 and the second longitudinal side 116 of the protective hood 51.

As shown in FIG. 15, the first stop surface 111 of the stop 110 and the second stop surface 122 of the mating stop 120 are arranged in relation to each other in such a way that their ends facing the arm 30 are arranged approximately in the same position arranged approximately in relation to a direction of the axis of rotation 8 of the tool 5. Since the second stop surface 122 is wider than the first stop surface 111, the end, facing away from the arm 30, of the second stop surface has a significantly greater distance from the arm than the end, facing away from the arm 30, of the first stop surface. It is thus ensured that even if the protective hood is deformed, for example by vibrations of the protective hood, the stop 110 with its entire first stop surface 111 comes to rest on the second stop surface 122 of the mating stop 120. If the protective hood 51 deforms, this is as a rule away from the arm 30, since this forms a single-sided stop for the protective hood 51.

In a further, alternative configuration of the work apparatus 1, provision is made, analogously to the shown embodiment, to also provide stops and counter-bodies, which make it possible to operate the work apparatus 1 with two directions of rotation of the tool 5.

1.-20. (canceled)

21. A work apparatus, comprising:
a housing (2);
a motor support unit (10) configured as a separate component from the housing (2), the housing (2) being fixed to the motor support unit (10);
a drive motor (3) arranged in the housing (2), the drive motor (3) being an electric motor for driving a tool (5), and attached to the motor support unit (10); and
a receptacle housing (20) configured as a separate component from the motor support unit (10) for receiving at least one battery pack (7, 7′) for supplying the drive motor (3) with electrical power,
wherein the receptacle housing (20) is fixed to the housing (2), and
wherein the receptacle housing (20) and the motor support unit (10) are configured and arranged relative to each other in such a way that the receptacle housing (20) is able to move relative to the motor support unit (10) in order to reduce or prevent direct transmission of inertial forces emanating from the receptacle housing (20) to the motor support unit (10) in an event of an impact load on the work apparatus (1).

22. The work apparatus according to claim 21,
wherein the motor support unit (10) and the receptacle housing (20) are connected to one another only via the housing (2).

23. The work apparatus according to claim 21,
wherein the motor support unit (10) and the receptacle housing (20) are arranged spaced apart from each other.

24. The work apparatus according to claim 21,
wherein each connection between the housing (2) and the motor support unit (10) and/or each connection between the housing (2) and the receptacle housing (20) is free of a separately formed antivibration element.

25. The work apparatus according to claim 21,
wherein the receptacle housing (20) has at least two receptacles (21, 22) for receiving two battery packs (7, 7′), and
wherein an opening (23) through which the motor support unit (10) projects is provided between the two receptacles (21, 22).

26. The work apparatus according to claim 21,
wherein a component rigidity of the motor support unit (10) is greater than a component rigidity of the housing (2).

27. The work apparatus according to claim 21,
wherein the housing (2) is formed from plastic.

28. The work apparatus according to claim 21,
wherein the motor support unit (10) is formed from a magnesium alloy.

29. The work apparatus according to claim 21,
wherein the work apparatus (1) has a rear handle (53) and a front handle (54),
wherein a control element (6) for controlling the drive motor (3) is coupled to the rear handle (53),
wherein the motor support unit has a rear end (27) and a front end (28),
wherein the rear end (27) faces away from the tool (5) and the front end (28) faces towards the tool (5), and
wherein the rear handle (53) is attached in a rear region of the motor support unit (10) and the front handle (54) is attached in a front region of the motor support unit (10).

30. The work apparatus according to claim 29,
wherein the rear handle (53) is attached at the rear end (27) and
wherein the front handle (54) is attached at the front end (27).

31. A work apparatus, comprising:
a housing (2);
a motor support unit (10) configured as a separate component from the housing (2), and connected to the housing (2);
a drive motor (3) arranged in the housing (2), the drive motor (3) being an electric motor, and attached to the motor support unit (10); and
a receptacle housing (20) having a first receptacle (21) and a second receptacle (22) for receiving one battery pack (7, 7′) each,
wherein the motor support unit (10) is arranged at least partially between the first receptacle (21) and the second receptacle (22).

32. The work apparatus according to claim 31,
wherein the motor support unit (10) has a middle section (13),
wherein the middle section has a first curvature (91) and a second curvature (92), and
wherein the first curvature (91) and the second curvature (92) run in opposite directions to each other.

33. The work apparatus according to claim 32,
wherein the first curvature (91) has a first axis of curvature (93),
wherein the second curvature (92) has a second axis of curvature (94), and
wherein the first axis of curvature (93) of the first curvature (91) and the second axis of curvature (94) of the second curvature (92) are aligned parallel to one another.

34. The work apparatus according to claim 32,
wherein the motor support unit (10) has a first longitudinal section (11) and a second longitudinal section (12) which are aligned in particular parallel to one another, and
wherein the first longitudinal section (11) and the second longitudinal section (12) are connected to one another via the middle section (11).

35. The work apparatus according to claim 34,
wherein the first longitudinal section (11) of the motor support unit (10) is arranged between the first receptacle (21) of the receptacle housing (20) and the second receptacle (22) of the receptacle housing (20), and
wherein the first receptacle (21) and the second receptacle (22) are receiving slots.

36. The work apparatus according to claim 34,
wherein the drive motor (3) is attached to the second longitudinal section (12) of the motor support unit (10).

37. The work apparatus according to claim 31,
wherein the motor support unit (10) is a motor support plate formed from a magnesium alloy.

38. The work apparatus according to claim 37,
wherein the motor support plate is a moulded component with a main demoulding direction (31), and
wherein the main demoulding direction (31) corresponds to the direction of an axis of rotation (4) of the drive motor (3).

39. The work apparatus according to claim 31,
wherein the work apparatus (1) has a rear handle (53) and a front handle (54),
wherein the rear handle (53) is coupled to an actuating element (6) for controlling the drive motor (3),
wherein the motor support unit has a rear end (27) and a front end (28), and
wherein the rear end (27) faces away from a tool (5) and the front end (28) faces towards the tool (5), and
wherein the rear handle (53) is attached in a rear region of the motor support unit (10) and the front handle (54) is attached in a front region of the motor support unit (10).

40. The work apparatus according to claim 31,
wherein the work apparatus is a cut-off machine or a chainsaw.
